(19) United States
(12) Patent Application Publication
(10) Pub. No.: US 2004/0168066 A1
(43) Pub. Date: Aug. 26, 2004

(54) Web site management system and method

(76) Inventor: Kathryn A. Alden, Sheffield, IA (US)

Correspondence Address: NIXON PEABODY, LLP, 401 9TH STREET, NW, SUITE 900, WASHINGTON, DC, 20004-2128, US

(21) Appl. No.: 10/785,183

(22) Filed: Feb. 25, 2004

Related U.S. Application Data
(60) Provisional application No. 60/449,397, filed on Feb. 25, 2003.

(51) Int. Cl. H04L 9/00

(52) U.S. Cl. 713/182; 713/155

(57) ABSTRACT

A system and method for the owner of a Web site to maintain his own off-line table of login names, passwords, and other authentication parameters, and submit them to a Web server for the purpose of allowing or denying access by others to the Web site. The Web site owner controls validation of users for access to the Web site or to a portion of the Web site without the need to obtain third-party Webmaster services.

### CROSS REFERENCE TO RELATED DOCUMENT

The present invention claims benefit of priority to commonly assigned, copending, U.S. Provisional Patent Application Serial No. 60/449,397 of Alden, entitled “Web Site Management System,” filed Feb. 25, 2003, the entire disclosure of which is hereby incorporated by reference in the present application.

### FIELD OF THE INVENTION

The invention relates generally to Web site management. More particularly, the invention relates to a system and method of managing a Web site by maintaining an off-line access table of authentication parameters to grant access to the Web site.

### BACKGROUND OF THE INVENTION

A computer network is composed of one or more client machines such as workstations, personal computers (PCs), laptop computers, access terminals and one or more servers. The purpose of a computer network is to allow sharing of electronic resources and devices such as text files and documents, database files, graphics, and multimedia files. The Internet is a network of publicly-accessible computer networks comprised of computers connected through routers utilizing communication protocols such as transmission control protocol/Internet protocol (TCP/IP) or any suitable communications protocol.

The World Wide Web (Web) is a vast international collection of electronic resources, files, and “pages” residing on the Internet. The Web presents information on the pages through a combination of text, pictures, audio clips, video clips, and other types of files. Each resource or page on the Web is identified by an electronic address known as a uniform resource locator (URL). The Web resources are accessed via Web browser software on client machines through which the user supplies the desired URL. The URL may point to a static resource such as a Web page document or it may point to a software program that resides on a Web server. A Web page may also contain any number of additional hypertext documents containing cross-references or “links” that allow the client to move easily from one Web page to another by navigating to and from other URLs on the Web.

A Web page document is written using an industry-standard markup language. A markup language is a method of writing a file document that contains structured information indicating the logical components of the document such as the content of the information and the role played by that content. The content may be words, pictures, database tables, and other information. The roles may include headings, embedded graphics, links to other Web pages, lists of authorized users, and other functions. Hypertext Markup Language (HTML) is an Internet standard for providing vendor-independent, platform-independent, and application-independent information in a structured document format. Web browser software such as Apple Safari®, Netscape Navigator® and Microsoft Internet Explorer® supports the use of HTML.

When a client machine successfully connects to the requested URL, the user may or may not be asked to identify himself by supplying certain information such as a login name and password. For a Web site that has not implemented an authentication process or other security measures, the information and resources on the site are accessible to any user from any client machine in the world.

An increasing number of private individuals and small-to-midsize organizations are discovering that having their own Web sites provides a relatively inexpensive and simple way to share information quickly and efficiently. “Do it yourself” Web page development tools that automatically generate HTML documents now place Web design within the reach of the general public. Families may display photographs of their children and of special events. Schools display photo-essays of academic organizations, sports events, and social functions. Dance studios may digitally record recitals and make the video clips available to those who could not attend. Small businesses offer products and services and publish newsletters. However, the inexperienced Web developer or Internet user may not fully realize the risks inherent in permitting unrestricted access to such information on their Web site.

Tools to provide security and manage access to information on the Internet can be cost-prohibitive and require technical expertise beyond the skill level of most Web site owners. In addition to security concerns in general, for business reasons it may be desirable that an owner maintain several tiers of access to its information on its Web site, compounding development and maintenance costs for the Web site owner even further. For example, a small manufacturing firm may also sell its products through retail and distributor channels. The firm may wish to implement two different pricing tiers for the products, and would want to restrict access by one group of sales representatives to the pricing information of another group of sales representatives. Previously, to implement a system of creating and managing access to information, a Web site owner was forced to rely upon professional programmers to implement sufficient security and management levels of control to safeguard their Web sites.

Additionally, when a Web site owner manages and updates end-user authentication parameters on-line, the Web site owner relies upon the persistent availability of the on-line service and of the on-line service provider. If the on-line service is down, or if local communication infrastructure is inconsistent or even non-existent, the Web site owner's site is down. Many rural and small communities do not have the necessary computer network infrastructure to rely upon consistent and uninterrupted service.

U.S. Pat. No. 6,381,602 appears to disclose a system for enforcing access control on secured documents that are stored outside of the direct control of the original application. Security access may be enforced by a search engine and an indexing system that compiles references to documents at multiple network locations. The search engine provides a user only those documents that the user is authorized to read. The indexing system may apply access control to protect the documents at their source location. However, the '602 patent is implemented in a network environment where documents and access controls are stored at various source locations. If the network is down, or if the end-user cannot access the particular access control location, the client is unable to properly update authentication parameters and access to the various file locations will not be possible.

Additionally, U.S. Pat. No. 6,185,567 appears to disclose a database where access by the user is authenticated by querying the user's central machine. The authentication process employs three checkpoints to determine and deliver a requested page to a Web browser. Access to a common database interface is provided over the Internet using a World Wide Web server, including a search engine, a CGI gateway and user selectable data queries for extracting data and generating reports. The '567 patent employs an authentication process using the Web browser to query a central authority to manage a database of users. If the Web browser is unable to connect to the central authority, or if the central authority cannot be accessed to update the authentication parameters, end-users will be unable to access the clients, as updated authentication parameters will not be loaded.

U.S. patent application Ser. No. U.S. 2002/0161903 is an example of a system for providing secure access to information provided by a Web application where the information is stored in a secure storage area in a remote network node. Each customer is allocated memory space in the secure storage area, and each customer may be authenticated prior to gaining access to the allocated memory space. While the '903 Application employs authentication prior to granting access, the access granted is to a secure area on the server rather than to a client's system. The '903 Application employs a parsing of a received Web page to invoke the security module, and the Web application link is activated by the parsing of an attribute of the received tag. If the Web browser is unable to reach the secured page to perform this parsing, the end-user will be unable to access the customer site since no authentication may occur.

None of the previous tools that provide security and manage access to Web site information are adequately tailored for novice programmers and computer users while providing safe, reliable, and robust means for managing Web site access. Additionally, no systems and methods of managing Web sites exist that provide this functionality at an affordable price.

What is needed is a new type of system and method for Web site management that provides acceptable levels of security at a reasonable cost and permits computer users with rudimentary skill levels to manage a Web site owner's authentication parameters in a secure manner.

### SUMMARY OF THE INVENTION

The present invention relates to a Web site management system, and in particular to a Web site management system that manages a Web site owner's authentication parameters off-line employing a method of passing encrypted authentication parameters to a server-side engine.

The present invention provides an elegant, simple, powerful, and inexpensive Web site management tool. The present invention advantageously includes a platform-independent, server-side software package that allows users to manage simple Web sites as well as complex, database-driven Web sites featuring asset management, forums, chat rooms, virtual shopping carts, calculators, statistical reports, text, audio files, video files, and other Web content.

The task of maintaining privacy and managing Internet security within a reasonable budget presents a difficult challenge to the Internet user and to the Web site designer whose skill set falls below that of professional programmers. This customer profile includes, but is not limited to, private individuals, small to midsize business organizations in all industry segments, as well as corporate departments and subsidiaries, healthcare entities, professional firms, and consultation firms. For the sake of further discussion, these typical customers profiled in this document who own a collection of Web pages stored on a Web server are referred to as Web site owners, Customers, or Clients depending upon the role they are performing. Additionally, a client workstation is the local computer on which locally-installed software resides. A Customer Account is equivalent to one particular Web site owned by one Customer. Also, an End-User (EU) is one distinct entity with controlled access to one distinct Customer Account Web site. One individual person may have multiple EU identities.

The present invention provides significant cost savings over on-line authentication systems by minimizing network connection times during authentication and update periods. Network connections are necessary only for the period of time necessary to transfer authentication parameters rather than the time period necessary to enter and edit authentication parameters and otherwise configure access databases resident on a provider server.

In practicing the present invention, Web site owners will improve their software skill set by using appropriate tools to manage access to their own Web site's pages without the need for professional programming help. Web site owners also gain a business advantage by managing authentication parameters and by providing access oversight to multiple Web pages in a cost-effective, centralized manner without incurring additional outside Web development charges and maintenance costs. Efficiencies in this area permit additional resources and attention to be focused on core business processes.

These advantages are accomplished through an authentication system and process under the control of the Web site owner. The Web site owner manages the authentication parameters off-line himself, without having to obtain costly Web programming expertise or services. Examples of authentication parameters include the login name and password, the authorized Web site's URL, the beginning date and ending date of permitted access to the particular Web page, the permitted length of each login session, the permitted location of the logins, such as which computers are permitted to access the site, and any additional access and usage parameters as required.

The authentication parameters are submitted to the server-side engine either via uploading an encrypted transaction set message through a simple file transfer protocol (FTP) process or by a direct and secure connection to the server-side engine.

Alternatively, the Web site owner may choose to set up his Web site as a separate entity outside the World Wide Web site utilizing the system and method of the present invention. The Web site owner would then implement the present invention as a “Members Only” feature by establishing a hyperlink to the present invention's main Web site. Alternatively, the Web site owner may choose to host his site within the Web site of the present invention, which means any and all access to his Web site must be authenticated by the process and system of the present invention. Authentication ensures that a user is who they claim to be.

The present invention provides a system and method to enable authentication by use of various techniques. For example, a Web site owner permits One-to-One authentication where one login is permitted access to one Web site. The login and Web site access may be shared among one or more users. Similarly, the present invention also provides a system and method to afford Many-to-One authentication where multiple logins are authenticated to access the same Web site. In Many-to-One environments, a distinct login is assigned to each user. Additionally, the present invention permits authentication where one login authenticates to multiple Web sites. This scenario is referred to as One-to-Many authentication. Also, Many-to-Many authentication is provided in the present invention where multiple logins are used to authenticate to multiple Web sites.

For example, a school could provide a common login name and password to the senior class officers, providing access to the site for only a one-week period. A dance studio could provide login names to each family who has a child participating in a dance recital, with a common password for all or individual passwords for each family. A business may use a multi-tiered marketing approach with one Web site for retail customers, one site for wholesale customers, and one site for each individual partner and consultant.

A nursing home, long-term care, or assisted living facility may be a Client with a particular Web site dedicated to that facility. The facility Web site may then have multiple Accounts under the Client, each of the Accounts representing a particular resident of the skilled care facility. End-Users of the Web site are assigned to a particular Account. For example, family members of a resident of the skilled care facility would be End-Users that could access the resident's Account of the skilled care facility Web site. In this hierarchical fashion, family members may be able to view resident's care plans, activity schedules, and other personal information such as photographs, while the resident's physician may access physical therapy reports, medication prescriptions, and patient charts related to that resident. The login and password control scenarios and authentication parameters set up appropriate pointers in a database, with each login control establishing pointers that point to potentially different types of content. The End-Users may then access the content to which they are permitted access by virtue of the login control.

Commercially designed and maintained Web sites would require Webmaster services each time a login, password, or any other authentication parameter was changed. The present invention permits the Web site owner to be his own Webmaster and to manage his own Web site security and access system.

### BRIEF DESCRIPTION OF THE DRAWINGS

The above-mentioned and other features and benefits of this invention and the manner of attaining them will become more apparent, and the invention itself will be better understood by reference to the following description of embodiments of the invention taken in conjunction with the accompanying figures where:

FIG. 1 is an illustration of a Web site management system in accordance with one embodiment of the invention.

FIG. 1A depicts modules of the present invention illustrating the functional flow of data in accordance with one embodiment of the invention.

FIG. 2 is a diagram illustrating the hierarchy of the account structure used in one embodiment of the invention.

FIG. 3 is an illustration of a Web site management system in accordance with a second embodiment of the invention using a direct connection.

FIGS. 4A, 4B, and 4C are flow diagrams illustrating the basic operation of the invention.

### DETAILED DESCRIPTION OF THE INVENTION

The invention is described in detail with particular reference to certain preferred embodiments, but within the spirit and scope of the invention, it is not limited to such embodiments. It will be apparent to those of skill in the art that various features, variations, and modifications can be included or excluded, within the limits defined by the claims and the requirements of a particular use.

The present invention extends the functionality of current Web site management tools by allowing Web site owners with beginning computer skills to manage and control public access to their Web sites. Website owners may now administer End-User authentication parameters off-line thereby limiting access to their Web site and preserving their content. The present system has many advantages over prior systems such as those requiring extensive software and programming resources to administer, because the off-line access administration permits the Web site owner to affordably and directly control the validation of a user to the Web site or to a portion of the Web site without the need to obtain third-party Webmaster services or to house large amounts of data on each Web site. The present invention allows Clients to periodically update the access and authentication information to their Web sites and puts the burden of housing the computing resources on the provider-server. In this fashion, functions required to be performed by the Clients are reduced, and computing resources are conserved.

By creating and managing authentication parameters and processes off-line, there is less reliance upon these communication links. Authentication parameters are available at all times by accessing locally-installed software. Further, with off-line management of authentication parameters, the End-User information is available at all times. In an on-line environment, as the browser moves from one item to the next, the first item is no longer available without reconnecting or otherwise re-accessing that particular HTML file. In an off-line environment, the information may be accessed and portably moved without the need for network resources. Additionally, in remote areas with greater demand on common communications infrastructure, or in high traffic areas, or during times of peak use, network access may be problematic. In an off-line environment, the Customer may edit and manipulate End-User authentication parameters at any time, and then choose to upload and update the provider server during periods of lower network traffic. In each of these cases, computing resources are conserved, wait times are greatly reduced, and the Customer saves time, money, and frustration.

Also, by creating and managing authentication parameters and processes off-line, apart from a network and server environment, the problem of maintaining version control over the authentication parameters is eliminated. The single, live copy of the authentication parameters is maintained by the Client. Changes, additions, deletions, and other modifications may be made by the Client in a local environment and uploaded to the provider-server. The immediate upload then overwrites the previous version of the authentication parameters on the provider-server. Additionally, by managing End-User authentication parameters and processes off-line, a Web site owner greatly reduces network computing resources and the overhead traffic on the client machine and on the on-line server. The result is an authentication service that is much more robust.

Further, by utilizing an off-line system for managing authentication and access to the Web site owner's site, an additional layer of security is added. In conventional systems, if a hacker penetrates the on-line system and authenticates as another user, the hacker can access the Web site owner's site as another valid End-User.

By creating and managing authentication parameters off-line, a single source of the authentication parameters is maintained. The table of authentication parameters is less vulnerable to security breaches because the client originates the tables. In addition to these availability and security issues, End-Users are concerned with their privacy. By relying upon an on-line service to manage authentication and access parameters, End-Users may be forced to share their account information with the provider. Confidentiality may be more easily compromised in such an on-line system of Web site management.

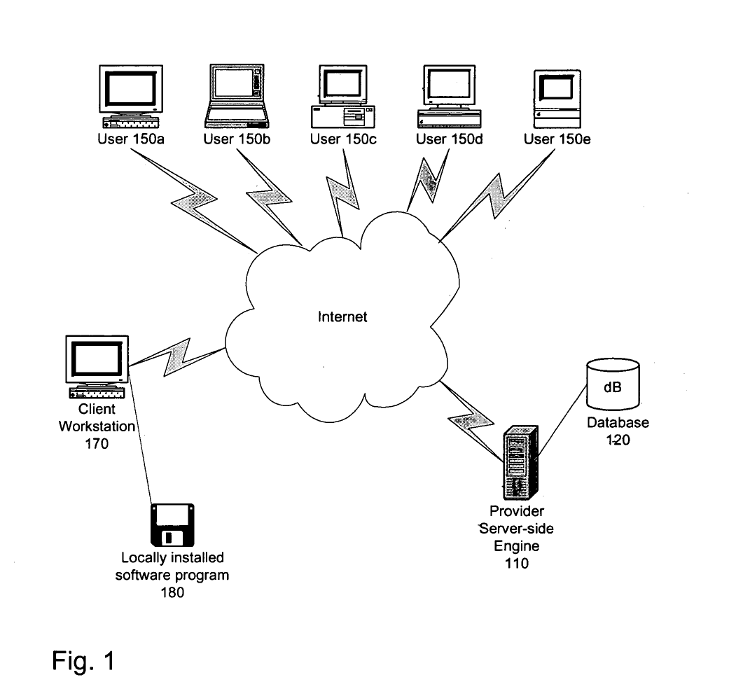

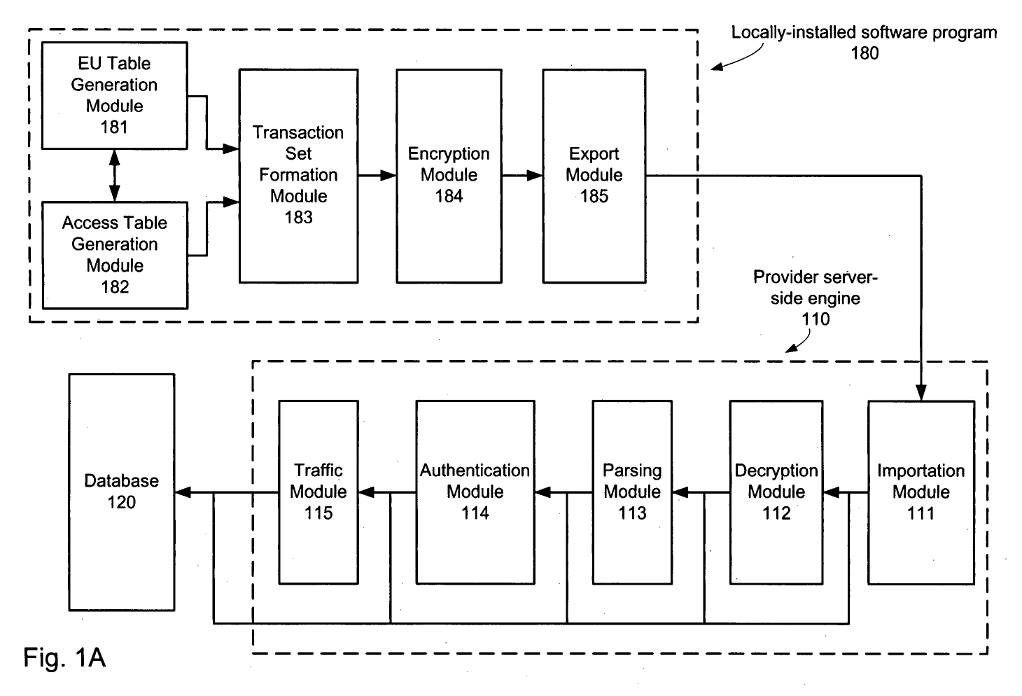

As shown in FIG. 1, the system of the invention includes a provider server-side engine 110 and a client workstation 170 connected by a computer network such as the. Internet by which End-Users 150 may access and use Web sites of the Clients.

The client workstation 170 is the local computer upon which resides the locally installed and licensed software program 180 that performs the method of the present invention. The locally installed software program 180 may be obtained via removable software products such as CD-ROM, floppy disks, magnetic tapes or the like, or by transfers from other computers. The locally installed software program 180 manages the Web site owner's authentication parameters off-line and provides the method of passing encrypted authentication parameters to the server-side engine 110. The locally installed software 180 stores, manipulates, encrypts, and exports from the client workstation 170 the Customer data required by the provider server-side engine 110. The locally installed software 180 resides off-line as opposed to residing on a Web server, and may contain additional tools providing enhanced capabilities and functionality such as automatic generation of HTML pages based upon data such as text, graphics, video files, audio files, and other database files. These database files supply the Web site owner with Webmaster development tools and features to further customize, supplement, and enhance her Web sites without the need to outsource the development to third-party software professionals.

As shown in FIG. 1A, locally-installed software program 180 is comprised of modules that perform specific operations to carry out the method of the present invention. The modules can be software sub-routines or program files called to perform specific operations to carry out the method of the present invention. While software modules are shown, it is to be understood that all or a portion of the exemplary embodiments can also be conveniently implemented by the preparation of application-specific integrated circuits or by interconnecting an appropriate network of component circuits. For simplicity and brevity, an exemplary embodiment utilizing software modules is shown in FIG. 1A.

The client-side workstation 170 provides secure access and manages end-user authentication parameters off-line by employing locally installed software program 180. Locally installed software program 180 includes an end-user (EU) table generation module 181 that generates and manages confidential personal and business data regarding End-Users of the Web site owner's Web sites off-line. While tables provide a convenient format with which to manipulate this information, it should be understood that any suitable representation of this data, such as HTML or XML files, or other markups and methods of conveying information and logical components of the data, may also be used.

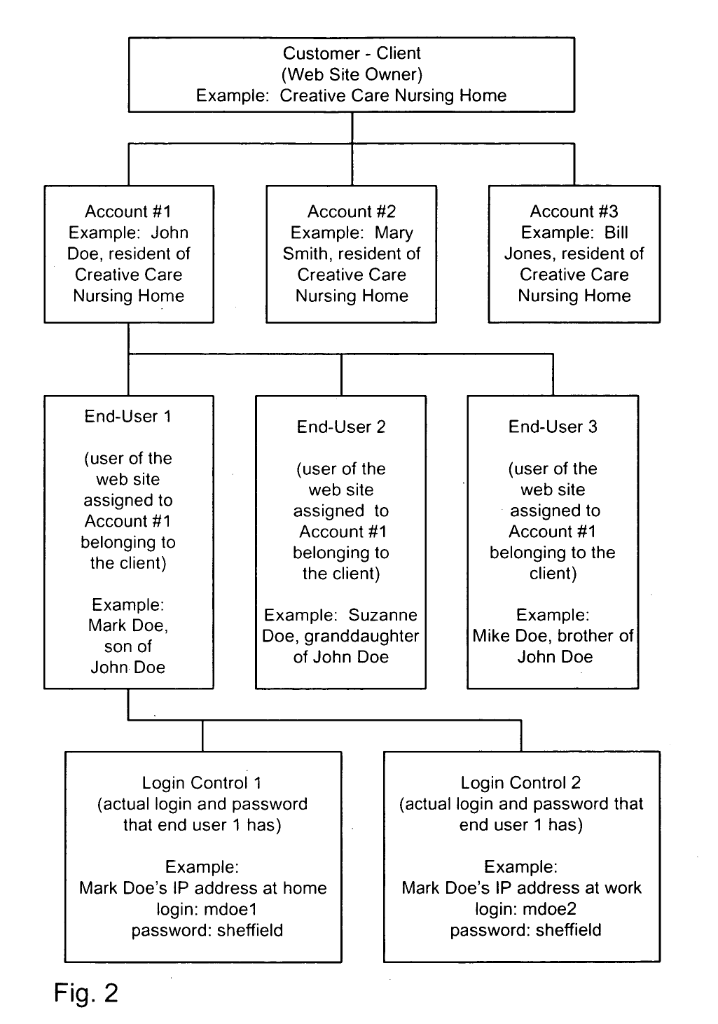

The purpose of the EU data is to uniquely identify End-Users accessing the client's various accounts. Clients may have an unlimited number of distinct Accounts, with an unlimited number of End-Users authenticated for each Account as shown in the account hierarchy depicted in FIG. 2.

For convenience and brevity, in FIG. 2 a single exemplary Customer is shown with three example accounts, but an unlimited number of Customers may be contracted, with an unlimited number of Accounts. Likewise, each account may have an unlimited number of End-Users, and the End-Users may have an unlimited number of Login Controls. While many more Login Controls may be associated with each End-User, for illustrative purposes and for brevity, two Login Controls are shown.

One embodiment of the present invention employs an (EU) table generation module 181 that produces the following information: Internal EU ID, Internal EU Counter Number, Account Number, EU ID Number, Active Start Date, Active End Date, Active (YIN), Priority Code, First Name, MI, Last Name, Preferred Name, Company Name, Title, Work Address 1, Work Address 2, Work City, Work State, Work Zip, Work Phone, Work Phone Extension, Work Mobile, Work FAX, Work Email, Work Website URL, Home Address 1, Home Address 2, Home City, Home State, Home Zip, Home Phone 1, Home Phone 2, Home Mobile, Home FAX, Home Email, Home Website URL, EIN, Relationship, Notes, and other pertinent personal information regarding the End-Users.

Additionally, the EU table may be supplemented with an EU Demographics Table to provide useful information about each End-User. A business client gains business advantage with this additional tool to manage pertinent End-User information. A personal client has a means of recording desired information about family and friends that can be used to trigger events, filter data for reports, and selectively direct an End-User to appropriate client Account Web sites. Exemplary contents of an EU Demographics Table includes Internal EU ID, Date of Birth, Birthplace, Gender, SSN, Marital Status, Anniversary, Spouse/Significant Other, Family Information, Primary Language, Secondary Language, Occupation, Date Occupation Since, Notes, and other pertinent demographic information regarding the End-Users. Further, data from the EU Table Generation Module 181 is linked to the Access Table Generation Module.

Locally installed software program 180 further includes Access Table Generation Module 182, which is linked to the EU Table Generation Module 181. Access Table Generation Module 182 generates, houses, and manages End-User Authentication Parameters off-line utilizing an End-User Authentication Parameters (EUAP) Table, which is the access table containing the authentication parameters, with full filtering, logging and reporting capabilities. This relationally linked access table is linked to the EU Table. The purpose of the EUAP record is to uniquely distinguish between End-Users accessing Client's various accounts. Clients may have an unlimited number of distinct Accounts, with an unlimited number of End-Users (EU) authenticated for each Account. The EUAP record distinguishes these individual Login Controls. The contents of a typical EUAP record include Internal EU ID, Login Name, Login Password, Beginning Date of Authentication Period, Ending Date of Authentication Period, EUAP Notes, Session Length, TimeOut, and other pertinent parameters that may be used to distinguish between discrete End-Users.

Also, the locally installed off-line software 180 includes the ability to set up an unlimited number of authorized users, as there is no limit on the number of records in the End-User table, and one End-User may have multiple login records in the access table. FIG. 2 illustrates the account hierarchy utilized in the present invention.

Locally installed software program 180 further includes Transaction Set Formation Module 183 that combines and formats entries from the Access Table Generation Module 182 and the End-User Table Generation Module 181 into a transaction set that includes all current end-user authentication parameters (EUAP) that establish rules to control access of the Web site owner's End-Users to Web site pages specified by the Web site owner. The Transaction Set Formation Module 183 defines the details of the Accounts and settings to be uploaded to the provider-server 110. Each transaction set defines one set of Client, Account, and Login Control data.

Additionally, locally installed software program 180 includes Encryption Module 184 that encrypts the transaction set from the Transaction Set Formation Module 183 prior to sending the transaction set to the provider server 110. As further discussed with regard to the method of the present invention, Encryption Module 184 encrypts the transaction set configuration file with the Advanced Encryption Standard (AES) using a one of several 16 byte keys with the Rjindael encryption algorithm. The encrypted file is then passed to the Export Module 185.

Export Module 185 of the locally installed software program 180 writes the encrypted authentication parameters of the transaction set to a server-side engine 110 via a computer network using FTP or other transfer protocol.

Once Export Module 185 exports the transaction set to the server-side engine, software modules installed on the server side engine perform additional operations upon the transaction set to effectively manage access to owners' Web sites using authentication parameters prepared off-line by the Client.

The server-side engine 110 routes and directs End-Users to client Web sites based upon rules embodied in the transaction set. The server-side engine 110 is comprised of an importation module 111 that receives the Web site owner's encrypted transaction set from the Export Module 185. The importation module 111 provides an automated import or direct-connect functionality to the client workstation 170 to receive the Web site owner's authentication parameters and a database of Customers (Web site owners), Customer accounts (one particular Web site or URL belonging to one particular Customer), and each Customer account's End-User authentication parameters as formed by Transaction Set Formation Module 183 and later encrypted and exported.

The server-side engine 110 further comprises a decryption module 112 that decrypts the authentication parameters of the transaction set from the importation module 111. These decrypted data are then routed to parsing module 113 that parses the transaction set information determining the syntactic structure of the transaction set after the transaction set information is decrypted by the decryption module 112.

Additionally, server-side engine employs an authentication module 114 that creates client accounts establishing customers, creating master login and authentication information templates for a Client to populate after creation of the Client Account, and verifying the transaction set provided by a client workstation 170 by way of locally installed software program 180 is that of a Customer.

Database module 120 on the provider server-side engine is used to store Customer information, Customer account information, messaging information, and End-User Authentication Parameters (EUAP) from the importation module 111 as well as intermediate data generated and used by decryption module 112, parsing module 113, and authentication module 114. Database module 120 further interacts with traffic module 115, which can include a common gateway interface (CGI), script or software program that can perform any number of server-side functions including communicating with the all modules of provider server-side engine 110 and database module 120 or other data source to dynamically produce the resource or results requested by the End-Users 150. Once the End-User's login name and password is authenticated for the particular Customer Web site, CGI script generates the session variables and points the End-User's browser to the owner's Web site.

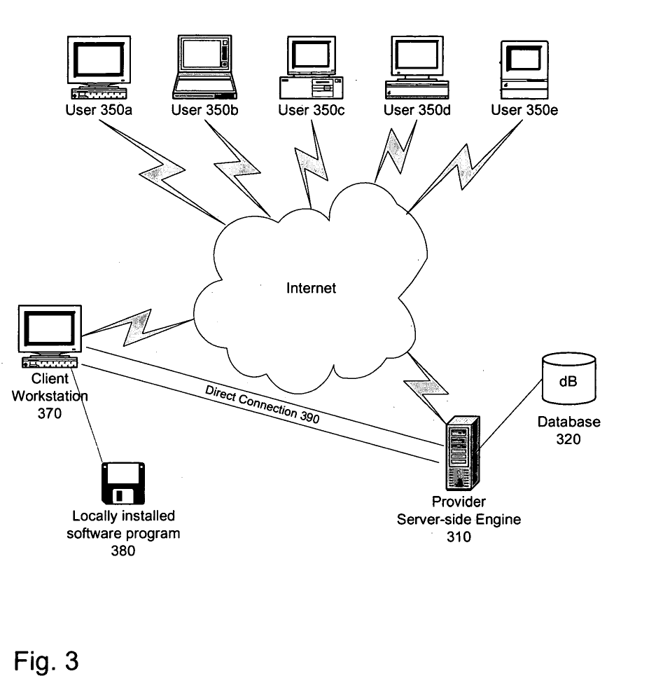

In addition to the Internet network connection depicted in FIG. 1, the present invention may alternatively employ a communication method between the client workstation 170 and provider server 110 by means of a secure direct connection as illustrated in FIG. 3.

In FIG. 3, the off-line locally installed software program 380 includes an export feature that writes an encrypted transaction set file to the server-side engine using FTP or other transfer protocols. The transaction set for the End-Users 350 is configured by the client's off-line software 380 and defines the details of the Accounts and settings to be uploaded to the provider-server 310. Regardless of the type of communication network employed to establish connection between client workstation 370 and provider server 310, each transaction set defines one set of corresponding data. That is, a client, Account, and the Login Control (EUAP).

An exemplary transaction set file is named in the following format:

| | |
|---|---|
| Characters 1-2: | TS |
| Characters 3-5: | Last three characters of the Customer Number |
| Characters 6-8: | Last three characters of the Account Number |
| Character 9: | A dash (-) |
| Characters 10-15: | The date the file was created in MMDDYY format. |
| Characters 16-21: | The time the file was created in HHMMSS format |
| Character 22: | A period (.) |
| Characters 23-25: | SET |

All values are padded with zeros in front if insufficient data is available.

A sample transaction set file would appear as follows:

Sample: TS003006-062703164236.SET

The translation of this sample is: Transaction Set with Customer Number ending in “003”, Account ending in “006”, created on Jun. 27, 2003 at 16:42.36.

Automated FTP functionality is included in the off-line software 380 as well as a direct-connect option 390 allowing the off-line software 380 to be uploaded over a secure connection 390 for the purpose of writing the Customer-created End-User authentication parameters directly into the provider server-side database 320. Additional functionality is included in the off-line software 380 to automatically generate HTML pages based on data such as text, graphics, sound, and other database files, thereby supplying a gamut of Webmaster development features to further empower the customer as a “Do it yourself” Webmaster.

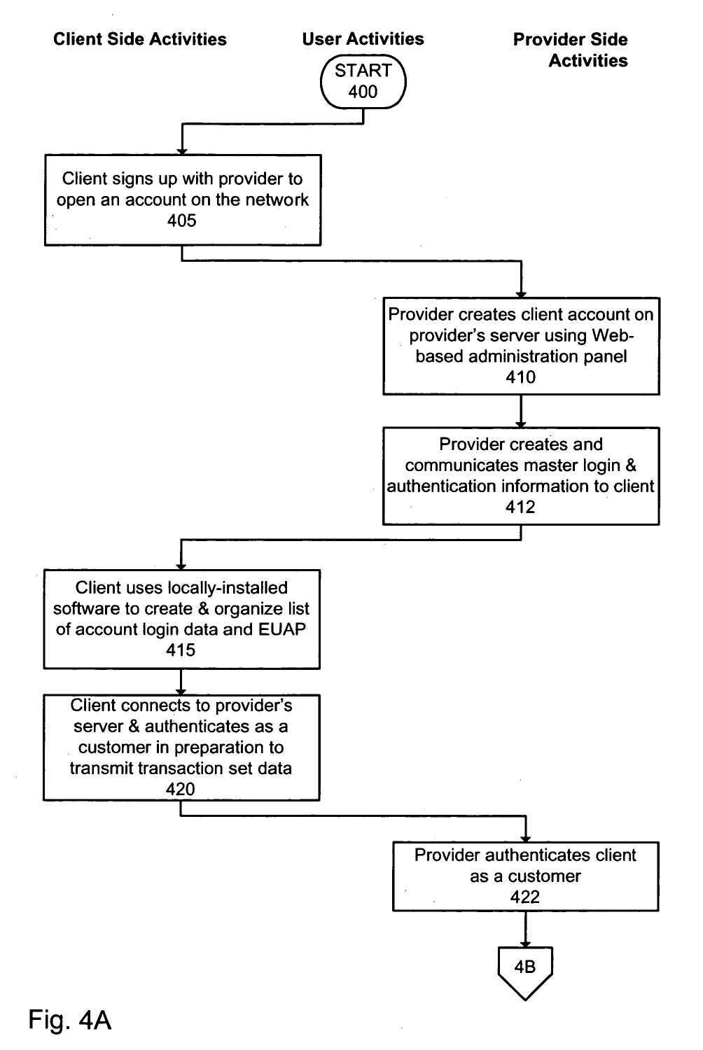

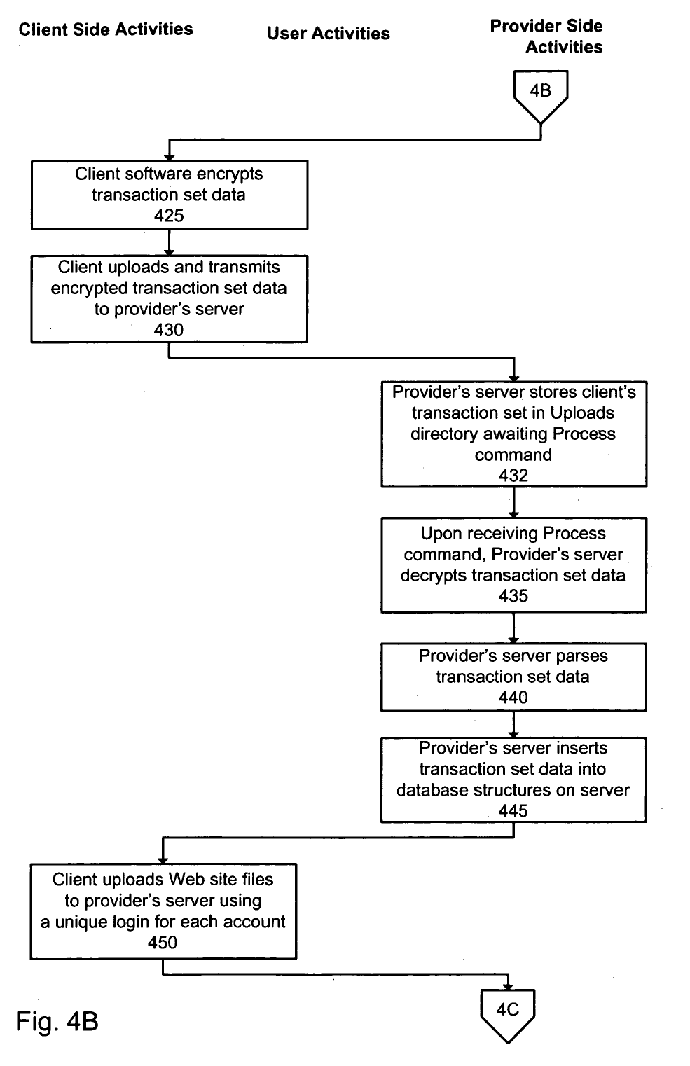

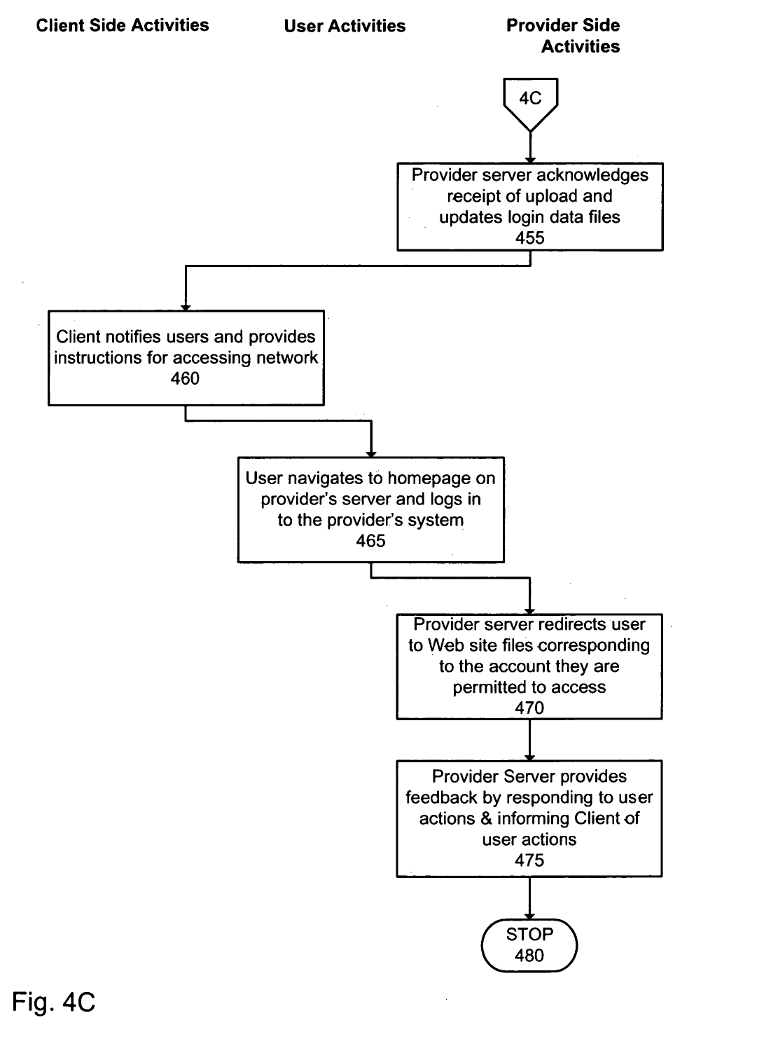

Referring now to FIGS. 4a and 4b, the method of the present invention is shown in a flow diagram with distinct client side activities, End-User activities, and provider-side activities shown in left, center, and right portions of the flow diagrams respectively.

The process begins in FIG. 4a at Start 400. At step 405, a client signs up with the provider performing the present invention to establish an account on the provider's network. The provider completes all signup activities that may be associated with establishing accounts including administration and maintenance of signup accounts.

At 410, the provider creates the client account on the provider's server using a Web-based administration panel. A control panel that is accessible only by the provider is used to insert new accounts into the provider system. The provider server assigns customer numbers, account numbers, and authentication codes. The provider establishes a Server Customer Table that contains one record per billed customer. As previously described, one Customer may have multiple Customer Accounts (capital “A,” Accounts) with any number of End-Users.

An exemplary Server Customer Table contains the following fields:

| | |
|---|---|
| Internal Customer ID | Agent Zip |
| Customer Number | Agent Phone |
| EIN/SSN | Agent Phone Extension |
| Customer Company Name | Agent FAX |
| Customer Contact Name | Agent Email |
| Customer Address 1 | Agent Website URL |
| Customer Address 2 | Software Name |
| Customer City | Software Version |
| Customer State | Software Registration Key |
| Customer Zip | Software Authorization Key |
| Customer Phone | Software Company Name |
| Customer Phone Extension | Software Contact Name |
| Customer FAX | Software Address 1 |
| Customer Email | Software Address 2 |
| Customer Website URL | Software City |
| Internal Agent ID | Software State |
| Agent Company Name | Software Zip |
| Agent Company Contact Name | Software Phone |
| Agent Address 1 | Software FAX |
| Agent Address 2 | Software Email |
| Agent City | Software Website URL |
| Agent State | |

The provider bills each Customer monthly via Email or the like for each Customer Number. The bill amount is determined by the number of active Customer accounts. The Customer information is checked and updated as necessary with each Transaction Set File uploaded and processed successfully.

At 412, the provider creates and communicates master login and authentication information to the clients.

At 415, the client uses locally-installed software supplied by the provider to create and organize a list of account login data and authentication information. The provider distributes periodic updates to the login data to the clients to ensure accurate profiles are on hand. After the client enters End-User authentication parameters (EUAP) to control access by the client's End-User to the client-specified Web pages, at 420 the client uses the provider's client-side software to connect to the provider's server and at 422 is authenticated by the provider's server as a Customer.

Continuing in FIG. 4B, at 425, the client-side software encrypts the configuration data in the transaction set, and at 430 sends the information to the provider's server. The client uses the provider's client-side locally-installed software to transmit configuration data and EUAP information. The upload is performed using a standard file transfer protocol (FTP) daemon located on the provider server. All clients use the same login and password information, and a transaction set defines the details of the accounts and settings.

A Transaction Set History Table is created and used to log pertinent information regarding the transaction set such as when the file is created, encrypted, and exported for uploading to the server-engine. An exemplary Transaction Set History Table contains the following fields:

Creation Date

Citated By (Login name of locally installed software)

File Name

File Location

Encryption Code

Test/Production Status

Upload Date

Process Date

File Copy

The information transmitted within the configuration files as the transaction set determines to which Customers and accounts the information is to be applied. The transaction set defines one set of data corresponding to a Customer, an Account, and the Login Control End-User authentication parameter.

The unencrypted transaction set file may be written in XML compliant format. An exemplary listing of the XML format and tags is shown in Appendix 1.

The transaction set configuration file is encrypted with the Advanced Encryption Standard (AES) using a one of several 16 byte keys with the Rjindael encryption algorithm. The encrypted file is then tagged at the top of the file with a code that specifies which encryption key was used to encode the file.

An exemplary file format of the encrypted transaction set is shown below: ------------- BEGIN FILE LISTING -------------

<key>#</key>--- Encrypted Data Here --- ------------- END FILE LISTING ---------------

The first line of the file contains the <key> tag which specifies a number (#) as the data component. The number corresponds to the 1-based index of the encryption key array (provided in a separate document). In order to decrypt the file, the <key> line must be removed from the top of the file. The key is looked up using the index number, and then the file is decrypted using that key and the remaining data in the file.

The key itself is not present in the file. Instead, the keys are present in both the client application and the server software, transmitted in person, and are in a particular order. The key code at the top of the file specifies which encryption key is to be used to decrypt the file.

The transferred files are named in accordance with a standard configuration file format. Since the provider's server expects a known configuration file format, at step 432, the provider's server stores the client's transaction set in an Uploads directory, where the data set awaits a Process command from the client.

Upon receiving the Process command, a script is initiated, and at 435 the provider's server decrypts the client's transaction set, checks the incoming parameters against the expected parameters to minimize the opportunity for security breaches, opens the provider's server's database, authenticates the customer number and account numbers, deletes old authentication parameter data for the current Customer and account, writes the new authentication parameters for the current Customer and Accounts, and archives the encrypted transaction set files in a customer-specific location. A Server Customer Account Table is used to house this information. The Server Customer Account Table contains one record per Customer Account. One Customer may have multiple Customer Accounts. An exemplary Server Customer Account Table includes the following fields.

Internal Customer ID

Customer Number

Internal Account ID

Account Number

Active Start Date

Active End Date

Engine Authentication Code

Account Type

The Server Customer Account Table is linked to the Server Stop Table used to direct the EU login to the correct Customer Web pages.

The transaction set configuration data is conveniently parsed into useful data elements at step 440. At 445, the provider's server inserts the client configuration data into database structures on the server side. At this point, now that the database structures are populated, the users are established, and the End-User information (end-user authentication parameters, EUAP) is stored in a usable format in the provider's server as a Server EUAP Table. The purpose of the Server EUAP Table is to uniquely distinguish between End-Users accessing client's various Accounts. Clients may have an unlimited number of distinct Accounts, with an unlimited number of End-Users authenticated for each Account. An exemplary Server EUAP Table includes the following fields:

Internal Account ID

Account Number

Internal EU ID

EU Number

Preferred Name

Email

FAX

Website URL

Priority Code

Login Name

Login Password

Beginning Date of Authentication Period

Ending Date of Authentication Period

Location Code

Session Length

End-User access to a Client Web site is thereby accomplished through a three-token login including Customer ID, Account ID, and End-User ID/Password.

The process continues at 450, where the client now uploads to the provider-server the actual Web site files that the End-Users will be accessing using a unique login for each account. Upon creation of an account for a client, the provider assigns a master login, such as the account number, and a master password to each client. The client uses this login and password to log into the FTP server. Upon login, the FTP server redirects the client to the correct Web site directory for the files to be transmitted. This login automatically puts the client into the main directory for the particular Account. This login and password is not viable for login to the provider network, but rather only to the FTP server for file transmission. Additionally, the provider's server may utilize Secure FTP (SFTP) to ensure security of sensitive data. The provider's server further permits files to be uploaded and deleted, but does not permit download capabilities for security reasons.

Continuing in FIG. 4C, at 455, the provider's server acknowledges receipt of the upload and updates the login data files. These files include a Server Transaction Set File Table which contains one record per Transaction Set File successfully uploaded and processed by the client. An exemplary Server Transaction Set File Table includes the following fields:

Transaction ID

Transaction File Creation Date

Transaction File Created By

Transaction File Test/Production Status

Transaction File Name

Transaction File Encryption Code

Once the Transaction Set File is successfully uploaded, processed, and recorded in the Server Transaction Set File Table, it is moved and saved in the Customer's /History directory. Also, an Email or other suitable notice is sent to the Customer notifying them of the successful Upload/Process activity.

At 460, the client notifies the users and provides instructions to the users for accessing the network. The client transmits the specifications for logging into the network. This includes an account ID corresponding to the account and the login and password for the individual user as well as any additional data such as security information or other access codes to distinguish permitted users. At 465, an End-User, after receiving instructions for accessing the Web site, navigates to the provider's homepage and logs into the system through a master login screen. Based upon the Login Control, at 470 the End-User is redirected as appropriate to the client Web site file corresponding to the Account that they are permitted to access. Based upon the various possible client and End-User actions and the configurations selected by the clients, the provider'server may respond to the End-User's actions with messages to the End-User, messages to the client, or other data as configured by the client or otherwise inform the client of the user's actions at 475. The messages may be default messages that go to all similar Customers, all similar Accounts, or all similar End-Users. The default messages may be stored in a Server Default Messages Table. An exemplary Server Default Messages Table may include the following fields:

Default Customer Header Message

Default Customer Welcome Message

Default Customer Goodbye Message

Default Customer General Message

Default Customer Account Header Message

Default Customer Account Welcome Message

Default Customer Account Goodbye Message

Default Customer Account General Message

Default Customer Account Unsuccessful Login Message

Default Customer Account Timeout Message

Default End-User Login Header Message

Default End-User Login Welcome Message

Default End-User Login Goodbye Message

Default End-User Login General Message

Default End-User Unsuccessful Login Message

If present in the Transaction Set file, a Customer's own default Customer, Customer Account, and End-User Login messages will over-ride the provider-server's default messages. The customized messages may also include header, welcome, goodbye, and general messages based upon the Customer, the Account accessed, the End-User, or the Login Control utilized to access the Web site.

At Stop 480, the authentication and Web site management process concludes, and the End-User may further navigate the Customer Web site.

The devices and subsystems of the exemplary embodiments can communicate, for example, over a communications network, and can include any suitable servers, workstations, personal computers (PCs), laptop computers, PDAs, Internet appliances, set top boxes, modems, handheld devices, telephones, cellular telephones, wireless devices, other devices, and the like, capable of performing the processes of the disclosed exemplary embodiments. The devices and subsystems, for example, can communicate with each other using any suitable protocol and can be implemented using a general-purpose computer system, and the like. One or more interface mechanisms can be employed, for example, including Internet access, telecommunications in any suitable form, such as voice, modem, and the like, wireless communications media, and the like. Accordingly, communications networks employed can include, for example, wireless communications networks, cellular communications networks, satellite communications networks, Public Switched Telephone Networks (PSTNs), Packet Data Networks (PDNs), the Internet, intranets, hybrid communications networks, combinations thereof, and the like. In addition, the communications networks employed can be the same or different networks.

As noted above, it is to be understood that the exemplary embodiments are for representative purposes, as many variations of the specific hardware used to implement the disclosed preferred embodiments are possible. For example, the functionality of the devices and the subsystems of the exemplary systems can be implemented via one or more programmed computer systems or devices. To implement such variations as well as other variations, a single computer system can be programmed to perform the special purpose functions of one or more of the devices and subsystems of the exemplary systems. On the other hand, two or more programmed computer systems or devices can be substituted for any one of the devices and subsystems of the exemplary systems. Accordingly, principles and advantages of distributed processing, such as redundancy, replication, and the like, also can be implemented, as desired, for example, to increase the robustness and performance of the exemplary embodiments.

The exemplary embodiments can be used to store information relating to various processes described herein. This information can be stored in one or more memories, such as a hard disk, optical disk, magneto-optical disk, RAM, and the like, of the devices and sub-systems of the exemplary systems. One or more databases of the devices and subsystems can store the information used to implement the exemplary embodiments. The databases can be organized using data structures, such as records, tables, arrays, fields, graphs, trees, lists, and the like, included in one or more memories, such as the memories listed above.

All or a portion of the exemplary embodiments can be conveniently implemented using one or more general-purpose computer systems, microprocessors, digital signal processors, micro-controllers, and the like, programmed according to the teachings of the disclosed exemplary embodiments. Appropriate software can be readily prepared by programmers of ordinary skill based on the teachings of the disclosed exemplary embodiments. In addition, the exemplary systems can be implemented by the preparation of application-specific integrated circuits or by interconnecting an appropriate network of component circuits.

While the present invention have been described in connection with a number of exemplary embodiments and implementations, the present invention is not so limited but rather covers various modifications and equivalent arrangements, which fall within the purview of the appended claims.

What is claimed is:

1. A Web site management system to administer a Web site owner's authentication parameters off-line, the system comprising:
a client-side engine that manages end-user authentication parameters off-line, the client side engine comprising:
an end-user table generation module that generates and manages personal and business data regarding end-users of the Web site owner's Web sites off-line;
an access table generation module linked to the end-user table generation module that generates and manages authentication parameters of end-users off-line to permit the end-users access to the Web site owner's Web sites;
a transaction set formation module that combines and formats entries from the end-user generation module and the access table generation module into a transaction set that includes all current end-user authentication parameters that establish rules to control access by the Web site owner's end-users to Web site pages specified by the Web site owner;
an encryption module that encrypts the transaction set of the transaction set formation module;
an export module that writes the encrypted authentication parameters of the encryption module as a transaction set to a server-side engine via a computer network; and
a server-side engine that routes and directs end-users to client Web sites based upon rules established by the transaction set, the server-side engine comprising:
an importation module that receives the Web site owner's encrypted transaction set from the export module;
a decryption module that decrypts the transaction set from the importation module;
a parsing module that parses the transaction set information after the transaction set information is decrypted by the decryption module;
an authentication module that creates client accounts that establish clients as customers of a network provider, creates master login and authentication information templates for a client to populate after creation of the client account, and verifies the transaction set provided by a client is that of a customer;
a database module that stores customer information, customer account information, messaging information, and end-user authentication parameters from the importation module, decryption module, parsing module, authentication module, and traffic module; and
a traffic module that communicates and responds to the database module to dynamically produce a resource requested by an end-user.

2. The off-line Web site management system of claim 1, wherein the end-user table generation module and access table generation module each output at least one of end-users' names, e-mail addresses, home addresses, home telephone numbers, work addresses, work telephone numbers, personal demographic information, and professional demographic information.

3. The off-line Web site management system of claim 1, wherein the end-user table generation module comprises an end-user demographics sub-module that provides demographic information about end-users.

4. The off-line Web site management system of claim 3, wherein the end-user demographics sub-module performs at least one of the following: triggers event notification, filters data for reports, and selectively directs an end-user to appropriate client account Web sites.

5. The off-line Web site management system of claim 1, wherein the end-user table generation module further comprises a first administrative sub-module providing filtering, logging, and reporting capabilities with regard to the access table contents and transaction set history.

6. The off-line Web site management system of claim 1, wherein the access table generation module further comprises a second administrative sub-module providing filtering, logging, and reporting capabilities with regard to the access table contents and transaction set history.

7. The off-line Web site management system of claim 1, wherein the transaction set written by the export module is sent to the server-side engine using file transfer protocol (FTP).

8. The off-line Web site management system of claim 1, wherein the export module transmits the transaction set authentication parameters using a direct connection to the server-side engine.

9. The off-line Web site management system of claim 1, wherein the server-side engine further comprises an automatic HTML page generation module to automatically generate HTML pages based on the transaction set from the importation module and customer account information.

10. The off-line Web site management system of claim 1, wherein the server-side engine further comprises an account messaging module operably connected to the traffic module to provide customer account-specific messages that override server-side default messages delivered and displayed to an end-user upon the end-user requesting resources.

11. The off-line Web site management system of claim 10, wherein the account messaging module provides customer account-specific messages that include at least one of account header messages, account welcome messages, account goodbye messages, account general messages, account unsuccessful login messages, and account timeout messages.

12. A Web site management system to administer a Web site owner's authentication parameters off-line, the system comprising:
a client-side engine that establishes authentication parameters off-line to grant users access to a client's Web site, the client-side engine comprising:
a first data generation module that generates and organizes data off-line, the data related to users of a client's Web site;
a second data generation module linked to the first data generation module, wherein the second data generation module generates and organizes user authentication parameters off-line, the user authentication parameters for accessing a client's web site;
a third data generation module that combines and formats data from the first data generation module and data from the second data generation module thereby creating data establishing rules to control access to the client's Web site and outputs the data establishing rules to control access to the client's Web site to a provider server-side engine; and
a provider server-side engine to route and direct end-users to client Web sites based upon rules established by the third data generation module, the provider server-side engine comprising:
a data storage module to store the data establishing rules to control access to the client's Web site provided by the third data generation module
a data validation module to validate the stored data establishing rules to control access to the client's Web site provided by the third data generation module and stored in the data storage module; and
a traffic module to direct end-users to the client Web site and provide additional files to end-users upon validation of the stored data by the data validation module.

13. The off-line Web site management system of claim 12, wherein the first data generation module and second data generation module each output at least one of end-users' names, e-mail addresses, home addresses, home telephone numbers, work addresses, work telephone numbers, personal demographic information, and professional demographic information.

14. The off-line Web site management system of claim 12, wherein the first data generation module comprises a first sub-module that provides demographic information about end-users.

15. The off-line Web site management system of claim 14, wherein the first sub-module performs at least one of the following: triggers event notification, filters data for reports, and selectively directs an end-user to appropriate client account Web sites.

16. The off-line Web site management system of claim 12, wherein the second data generation module further comprises a second sub-module providing filtering, logging, and reporting capabilities.

17. The off-line Web site management system of claim 12, wherein the data establishing rules to control access to the client's Web site to a provider server-side engine is sent to the provider server-side engine using file transfer protocol (FTP).

18. The off-line Web site management system of claim 12, wherein the data establishing rules to control access to the client's Web site is sent to the provider server-side engine using a direct connection to the provider server-side engine.

19. The off-line Web site management system of claim 12, wherein the server-side engine further comprises an automatic HTML page generation module to automatically generate HTML pages based on data establishing rules to control access to the client's Web site and customer account information.

20. The off-line Web site management system of claim 12, wherein the server-side engine further comprises an account messaging module operably connected to the traffic module to provide customer account-specific messages that override server-side default messages delivered and displayed to an end-user upon the end-user requesting resources.

21. The off-line Web site management system of claim 20, wherein the account messaging module provides customer account-specific messages that include at least one of account header messages, account welcome messages, account goodbye messages, account general messages, account unsuccessful login messages, and account timeout messages.

22. A method for managing Web site access off-line, the method comprising the steps of:
creating an end-user table off-line, the end-user table containing personal and business information regarding a Web site owner's end-users;
creating an access table off-line, the access table relationally linked to the end-user table and containing authentication parameters regarding a Web site owner's end-users;
combining and formatting the contents of the end-user table and the access table into a transaction set off-line, the transaction set including all current end-user authentication parameters, the end-user authentication parameters establishing rules to control access by the Web site owner's end-users to Web site pages specified by the Web site owner; and
exporting the transaction set to a provider server, the provider server then implementing the rules established by the end-user authentication parameters to control access by the Web site owner's end-users to Web site pages specified by the Web site owner.

23. The off-line method for managing Web site access of claim 22, further comprising the steps of filtering, logging, and reporting end-user table contents.

24. The off-line method for managing Web site access of claim 22, further comprising the steps of filtering, logging, and reporting access table contents.

25. The off-line method for managing Web site access of claim 22, wherein the exporting step further comprises transferring by FTP.

26. The off-line method for managing Web site access of claim 22, wherein the exporting step further comprises transferring by a secure direct connection to a provider server.

27. The off-line method for managing Web site access of claim 22, further comprising the step of the provider server automatically generating HTML pages based on the transaction set and customer account information and providing the HTML pages to an end user.

28. The off-line method for managing Web site access of claim 27, further comprising the step of the provider server automatically generating HTML pages that include at least one of account header messages, account welcome messages, account goodbye messages, account general messages, and account unsuccessful login messages, and account timeout messages.

29. A data storage medium with computer-executable instructions for managing Web site access off-line, the data storage medium comprising:
locally installed instructions for creating an end-user table off-line, the end-user table containing personal and business information regarding a Web site owner's end-users;
locally installed instructions for creating an access table off-line, the access table relationally linked to the end-user table and containing authentication parameters regarding a Web site owner's end-users;
locally installed instructions for combining and formatting entries from the end-user table and the access table into a transaction set that includes all current end-user authentication parameters, the end-user authentication parameters establishing rules to control access by the Web site owner's end-users to Web site pages specified by the Web site owner;
locally installed instructions for encrypting the transaction set; and
locally installed instructions for exporting the encrypted transaction set to a provider server, the provider server then executing instructions for implementing the rules established by the end-user authentication parameters to control access by the Web site owner's end-users to Web site pages specified by the Web site owner.

30. The data storage medium of claim 29, wherein the locally installed instructions for creating an end-user table further comprises full filtering, logging, and reporting end-user table contents.

31. The data storage medium of claim 29, wherein the locally installed instructions for creating an access table further comprises full filtering, logging, and reporting access table contents.

32. The data storage medium of claim 29, wherein the locally installed instructions for exporting the transaction set further comprises transferring by FTP.

33. The data storage medium of claim 29, wherein the locally installed instructions for exporting the transaction set further comprises transferring by a secure direct connection to a provider server.

34. The data storage medium of claim 29, wherein the locally installed instructions further comprises instructions for the provider server automatically generating HTML pages based on the transaction set and customer account information and providing the HTML pages to an end-user.

35. The data storage medium of claim 34, further comprising locally installed instructions for the provider server automatically generating HTML pages that include at least one of account header messages, account welcome messages, account goodbye messages, account general messages, and account unsuccessful login messages, and account timeout messages.

36. A workstation for administering a Web site owner's authentication parameters off-line, the workstation comprising:
an end-user table generation module that generates and manages personal and business data regarding end-users of the Web site owner's Web sites off-line;
an access table generation module linked to the end-user table generation module that generates and manages authentication parameters of end-users off-line to permit the end-users access to the Web site owner's Web sites;
a transaction set formation module that combines and formats entries from the end-user generation module and the access table generation module into a transaction set that includes all current end-user authentication parameters that establish rules to control access by the Web site owner's end-users to Web site pages specified by the Web site owner;
an encryption module that encrypts the transaction set of the transaction set formation module;
an export module that writes the encrypted authentication parameters of the encryption module as a transaction set to a server-side engine.

37. The workstation for administering a Web site owner's authentication parameters off-line of claim 36, wherein the end-user table generation module and access table generation module each output at least one of end-users' names, e-mail addresses, home addresses, home telephone numbers, work addresses, work telephone numbers, personal demographic information, and professional demographic information.

38. The workstation for administering a Web site owner's authentication parameters off-line of claim 36, wherein the end-user table generation module comprises an end-user demographics sub-module that provides demographic information about end-users.

39. The workstation for administering a Web site owner's authentication parameters off-line of claim 38, wherein the end-user demographics sub-module performs at least one of the following: triggers event notification, filters data for reports, and selectively directs an end-user to appropriate client account Web sites.

40. The workstation for administering a Web site owner's authentication parameters off-line of claim 36, wherein the end-user table generation module further comprises a first administrative sub-module providing filtering, logging, and reporting capabilities with regard to the end-user table contents and transaction set history.

41. The workstation for administering a Web site owner's authentication parameters off-line of claim 36, wherein the access table generation module further comprises a second administrative sub-module providing filtering, logging, and reporting capabilities with regard to the access table contents and transaction set history.

42. The workstation for administering a Web site owner's authentication parameters off-line of claim 36, wherein the transaction set written by the export module is sent to the server-side engine using file transfer protocol (FTP).

43. The workstation for administering a Web site owner's authentication parameters off-line of claim 36, wherein the export module transmits the transaction set authentication parameters using a direct connection to the server-side engine.

44. A workstation for administering a Web site owner's authentication parameters off-line, the workstation comprising:
a first data generation module that generates and organizes data off-line, the data related to users of a client's Web site;
a second data generation module linked to the first data generation module, wherein the second data generation module generates and organizes user authentication parameters off-line, the user authentication parameters for accessing a client's web site; and
a third data generation module that combines and formats data from the first data generation module and data from the second data generation module thereby creating data establishing rules to control access to the client's Web site and outputs the data establishing rules to control access to the client's Web site to a provider server-side engine.

45. The workstation for administering a Web site owner's authentication parameters off-line of claim 44, wherein the first data generation module and second data generation module each output at least one of end-users' names, e-mail addresses, home addresses, home telephone numbers, work addresses, work telephone numbers, personal demographic information, and professional demographic information.

46. The workstation for administering a Web site owner's authentication parameters off-line of claim 44, wherein the first data generation module comprises a first sub-module that provides demographic information about end-users.

47. The workstation for administering a Web site owner's authentication parameters off-line of claim 46, wherein the first sub-module performs at least one of the following: triggers event notification, filters data for reports, and selectively directs an end-user to appropriate client account Web sites.

48. The workstation for administering a Web site owner's authentication parameters off-line of claim 44, wherein the second data generation module further comprises a second sub-module providing filtering, logging, and reporting capabilities.

49. The workstation for administering a Web site owner's authentication parameters off-line of claim 48, wherein the second sub-module performs at least one of the following: triggers event notification, filters data for reports, and selectively directs an end-user to appropriate client account Web sites.

50. The workstation for administering a Web site owner's authentication parameters off-line of claim 44, wherein the data establishing rules to control access to the client's Web site to a provider server-side engine is sent to the provider server-side engine using file transfer protocol (FTP).

51. The workstation for administering a Web site owner's authentication parameters off-line of claim 44, wherein the data establishing rules to control access to the client's Web site is sent to the provider server-side engine using a direct connection to the provider server-side engine.

52. A method for administering a Web site owner's authentication parameters off-line, the method comprising the steps of:
creating a first data set off-line, the first data set related to users of a client's Web site;
creating a second data set off-line, wherein the second data set is linked to the first data set, and wherein the second data set contains parameters for accessing a client's Web site; and
combining and formatting contents of the first data set and contents of the second data set into a third data set, the third data set establishing rules to control access to the client's Web site; and
exporting the third data set establishing rules to control access to the client's Web site to a provider server-side engine.

53. The method for administering a Web site owner's authentication parameters off-line of claim 52, wherein the first data set and the second data set each contain at least one of end-users' names, e-mail addresses, home addresses, home telephone numbers, work addresses, work telephone numbers, personal demographic information, and professional demographic information.

54. The method for administering a Web site owner's authentication parameters off-line of claim 52, further comprising the steps of filtering, logging, and reporting contents of the first data set.

55. The method for administering a Web site owner's authentication parameters off-line of claim 52, further comprising the steps of filtering, logging, and reporting contents of the second data set.

56. The method for administering a Web site owner's authentication parameters off-line of claim 52, further comprising the step of selectively directing an end-user to client account Web sites.

57. The method for administering a Web site owner's authentication parameters off-line of claim 52, wherein the exporting the third data set establishing rules to control access to the client's Web site is sent to the provider server-side engine using file transfer protocol (FTP).

58. The method for administering a Web site owner's authentication parameters off-line of claim 52, wherein the exporting the third data set establishing rules to control access to the client's Web site is sent to the provider server-side engine using a direct connection to the provider server-side engine.
